(19) United States
(12) Patent Application Publication
(10) Pub. No.: US 2018/0260787 A1
(43) Pub. Date: Sep. 13, 2018

(54) SYSTEMS, METHODS AND DEVICES FOR DRIVER-RIDER MATCHING ADAPTABLE TO MULTIPLE RIDESHARE MODELS

(71) Applicant: GM GLOBAL TECHNOLOGY OPERATIONS LLC, Detroit, MI (US)

(72) Inventor: Xiaomin Xi, Warren, MI (US)

(73) Assignee: GM GLOBAL TECHNOLOGY OPERATIONS LLC, Detroit, MI (US)

(21) Appl. No.: 15/457,385

(22) Filed: Mar. 13, 2017

(51) Int. Cl. G06Q 10/10; G01C 21/34

(52) U.S. Cl. CPC G06Q 10/1095; G01C 21/343

(57) ABSTRACT

Disclosed are driver-rider matching algorithms, multimodal automated ridesharing systems, and dedicated mobile applications for provisioning rideshare services. A method is disclosed for matching prospective riders with available drivers associated with an automated ridesharing system. The method includes receiving a ride request from a prospective rider, and determining scheduling and preference data for that prospective rider. A set of available drivers currently or prospectively within a predetermined proximity of the prospective rider, if any, is then created. Driver scheduling and preference data is determined for each available driver in the set. The method then determines if the requesting rider matches with any of the available drivers in the set by comparing the rider's scheduling and preference data with the driver's scheduling and preference data. If the prospective rider matches with at least one available driver, a confirmation of the match is responsively transmitted to the prospective rider and the matched driver.

### INTRODUCTION

The present disclosure relates generally to ridesharing services for matching registered drivers with prospective ride-seeking passengers. More specifically, aspects of this disclosure relate to multimodal automated ridesharing systems and control algorithms for provisioning real-time rideshare transportation services.

Ridesharing has taken on many forms, whether it be as public transportation, such as riding a bus or train, or private car service, such as shuttle vans or limousines, or carpooling, where a group of people take turns driving the group to a destination point in their individually owned vehicles. In modern-day use, however, the term “ridesharing” is more commonly associated with an automated ridesharing system, provisioned by way of multiple computer-networked devices, for pairing registered drivers with ride-seeking passengers. In one form, a prospective passenger accesses a dedicated mobile application (or “app”) or web-based applet on a personal smartphone or other handheld computing device to be matched with and travel in a private vehicle driven by its owner. This service typically requires the rider pay a fee that is shared between the driver and a third party intermediary. Many automated ridesharing providers now offer carpooling and/or fee splitting features to incentivize multiple riders to ride with a single driver. When multiple people use a single vehicle in a same instance of time during ridesharing, each person's attendant costs are reduced because travel costs, such as fuel, maintenance, and tolls, are typically split among the persons using the vehicle. Moreover, the sharing of vehicles by passengers helps to reduce traffic congestion and automobile emissions.

### SUMMARY

Disclosed herein are driver-rider matching algorithms adaptable to multiple rideshare models, multimodal automated ridesharing systems for implementing driver-rider matching operations, and dedicated rideshare mobile applications for provisioning driver-rider matching. By way of example, and not limitation, there is presented an adaptable driver-rider matching algorithm that pairs rideshare drivers with prospective riders based on both the driver's and each rider's travel requirements (e.g., origin, destination, travel time window, etc.) and stated preferences (e.g., role as driver or rider, gender, match rating requirement, blacklist, friend circle, first-mile and last-mile pick-up, etc.). Filter-sort-assign batch processing operations are employed to identify feasible pairs for multiple drivers and multiple riders, then sort pairs based on defined metrics, and then assign matches in sorted order. The algorithm may apply a look-ahead-and-look-back strategy and a travel request prioritization strategy to help minimize the chances of stranded riders.

Attendant benefits for at least some of the disclosed concepts include a multimodal driver-rider matching process that may be employed for a variety of advance rideshare models. Disclosed systems, methods and devices may utilize batch processing of rider and driver requests for future travel; advance processing of this type helps to maximize the probability of matching drivers and riders. Driver-rider matching architectures and processes disclosed herein may be adapted to real-time and dynamic ride share models that quickly process driver and rider requests. Other attendant benefits may include the ability to match a driver with multiple riders and/or the ability to reroute and rematch drivers if a logistically improved set of pairings is determined. Another advantage may include the ability to process many types of user preferences for both drivers and riders, including role (driver vs. rider), gender, match rating limitations, blacklist, friend circle, first- and last-mile pick-up restrictions, max travel time or distance, max detour time or distance etc.

Aspects of the present disclosure are directed to driver-rider matching algorithms adaptable to multiple rideshare models. Disclosed, for example, is a method for matching one or more prospective riders with one or more available drivers associated with an automated ridesharing system. This method includes, in any order and in any combination with any of the disclosed features and options: receiving a ride request from a requesting one of the prospective riders; determining rider scheduling and preference data for the requesting prospective rider; determining a set of available drivers composed of one or more of the drivers that is/are currently or prospectively within a predetermined proximity of the requesting prospective rider, if any; determining respective driver scheduling and preference data for each available driver in the set; determining if the requesting prospective rider matches with any of the available drivers in the set by comparing the rider scheduling and preference data with the driver scheduling and preference data; and, responsive to a determination that the requesting prospective rider matches with at least one of the available drivers in the set, transmitting confirmation of the match to the requesting prospective rider and each matched available driver.

Other aspects of the present disclosure are directed to multimodal automated ridesharing systems for implementing driver-rider matching operations. Disclosed, for example, is an automated ridesharing system composed of one or more server processors, one or more communication devices, and one or more memory devices. Each server processor is communicatively connected to one or more data storage modules. In addition, each communication device is operable to communicatively connect at least one of the server processor(s) with a match engine and/or a map/routing engine over a distributed computer network. Each memory device is communicatively connected to at least one of the server processor(s).

At least one memory device of the automated ridesharing system stores processor-executable instructions. These processor-executable instructions include, in any order and in any combination with any of the disclosed features and options: process a ride request received from a personal computing device of a requesting one of a plurality of prospective riders; call up, from at least one of the one or more data storage modules, rider scheduling and preference data for the requesting prospective rider; create, from a registry of drivers associated with the automated ridesharing system, a set of one or more available drivers currently or prospectively within a predetermined proximity of the requesting prospective rider, if any; call up, from at least one of the one or more data storage modules, respective driver scheduling and preference data for each of the available drivers in the set; compare the rider's scheduling and preference data with each driver's scheduling and preference data to determine if the requesting prospective rider matches with any of the available drivers in the set; and, in response to a determination that the requesting prospective rider matches with at least one of the available drivers in the set, transmit confirmation of the match to the requesting prospective rider and the matched available driver.

The aforementioned method and/or processor-executable instructions may further include: receiving a ride offer from one or more of the available drivers; determining a set of the prospective riders from which ride requests have been received; and, determining respective rider scheduling and preference data for each of the requesting prospective riders in the set of prospective riders. Optionally, the method and/or processor-executable instructions may further include: determining if each offering driver matches with any of the prospective riders in the set based on the respective rider scheduling and preference data of each rider and the respective driver scheduling and preference data of each offering driver; and, responsive to each determination that a prospective rider in the set matches with an offering available driver, transmitting confirmation of the match to each of the prospective riders and the offering available driver. As yet another option, the aforementioned method and/or processor-executable instructions may further include: determining a seating capacity sufficient to accommodate the ride request from the requesting rider; determining which drivers in the set of available drivers do not have an available seating capacity greater than or equal to the sufficient seating capacity for the ride request; and, eliminating from the set any driver who's available seating capacity is not greater than or equal to the sufficient seating capacity for the ride request. Another optional operation may include, responsive to a determination that the requesting rider does not match with any available drivers: performing one or more new determinations of whether or not the requesting rider matches with any of the available drivers; and/or saving the ride request for a predetermined period of time during which a new match determination is performed.

The above summary is not intended to represent every embodiment or every aspect of the present disclosure. Rather, the foregoing summary merely provides an exemplification of some of the novel aspects and features set forth herein. The above features and advantages, and other features and advantages of the present disclosure, will be readily apparent from the following detailed description of representative embodiments and representative modes for carrying out the present disclosure when taken in connection with the accompanying drawings and the appended claims. Moreover, this disclosure expressly includes any and all combinations and subcombinations of the elements and features presented above and below.

### BRIEF DESCRIPTION OF THE DRAWINGS

FIG. 1 is a schematic diagram of a representative automated ridesharing system architecture for implementing driver-rider matching operations in accordance with aspects of the present disclosure.

FIG. 2 is a flowchart for a representative driver-rider matching procedure or algorithm that can be executed, for example, by one or more dedicated server components, programmable electronic control units, or other computer-based devices in accord with aspects of the disclosed concepts.

FIG. 3 is a series of schematic illustrations of a representative rideshare environment with an adaptable algorithm for matching multiple registered drivers with multiple prospective riders in accordance with aspects of the present disclosure.

The present disclosure is susceptible to various modifications and alternative forms, and some representative embodiments have been shown by way of example in the drawings and will be described in detail herein. It should be understood, however, that the novel aspects of this disclosure are not limited to the particular forms illustrated in the appended drawings. Rather, the disclosure is to cover all modifications, equivalents, combinations, subcombinations, permutations, groupings, and alternatives falling within the scope and spirit of the disclosure as defined by the appended claims.

### DETAILED DESCRIPTION

This disclosure is susceptible of embodiment in many different forms. There are shown in the drawings and will herein be described in detail representative embodiments of the disclosure with the understanding that these representative embodiments are to be considered an exemplification of the principles of the disclosure and are not intended to limit the broad aspects of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference or otherwise. For purposes of the present detailed description, unless specifically disclaimed: the singular includes the plural and vice versa; the words “and” and “or” shall be both conjunctive and disjunctive; the word “all” means “any and all”; the word “any” means “any and all”; and the words “including” and “comprising” and “having” mean “including without limitation.” Moreover, words of approximation, such as “about,” “almost,” “substantially,” “approximately,” and the like, may be used herein in the sense of “at, near, or nearly at,” or “within 3-5% of,” or “within acceptable manufacturing tolerances,” or any logical combination thereof, for example.

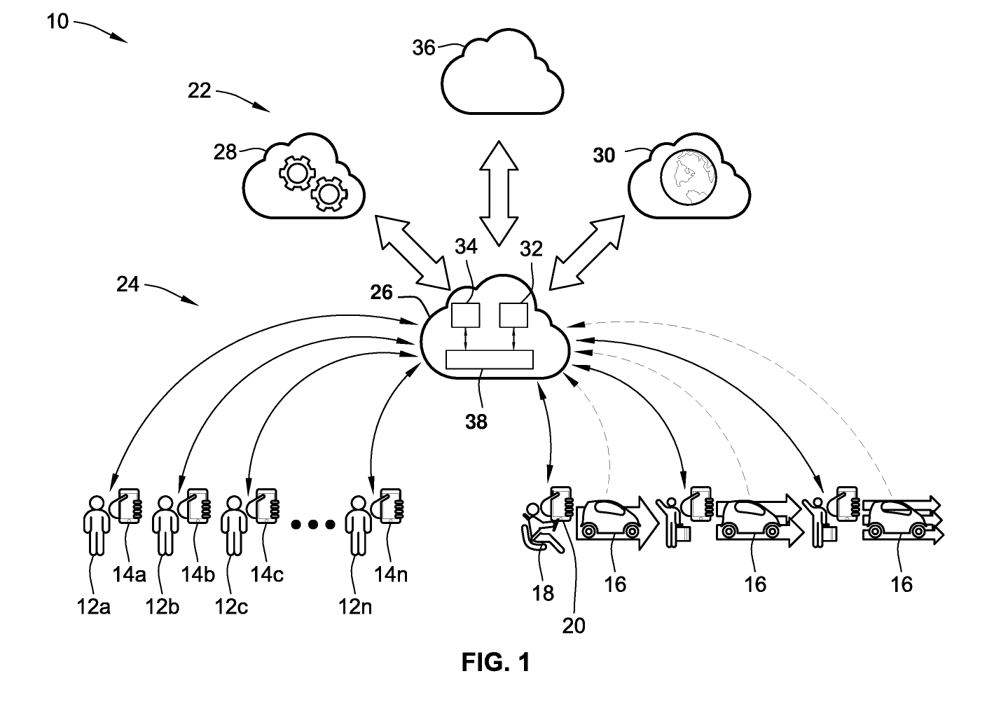

Referring now to the drawings, wherein like reference numbers refer to like features throughout the several views, there is shown in FIG. 1 a schematic illustration of a representative multimodal computer-networked ridesharing system, designated generally at 10, for provisioning driver-rider matching as part of an automated ridesharing service. The illustrated ridesharing system architecture 10 is merely an exemplary application with which the novel aspects and features of this disclosure may be practiced. In the same vein, implementation of the present concepts for the specific number and type of users illustrated in FIG. 1 should also be appreciated as an exemplary application of the novel concepts disclosed herein. As such, it will be understood that aspects and features of the present disclosure may be applied to any number and type of passenger and/or driver, and implemented by other automated ridesharing system architectures. Moreover, only select components of the system 10 have been shown and will be described in additional detail herein. Nevertheless, the systems and devices discussed herein can include numerous additional and alternative features, and other well-known peripheral components, for example, for carrying out the various methods and functions of this disclosure. Lastly, the drawings presented herein are not necessarily to scale and are provided purely for instructional purposes. Thus, the specific and relative dimensions shown in the drawings are not to be construed as limiting.

In the representative architecture presented in FIG. 1, the automated ridesharing system 10 is part of a distributed computing network operable for conducting transactions over a wireless communications system using portable electronic devices. As shown, one or more prospective riders, such as first, second, third, and Nth riders 12A, 12B, 12C and 12N, respectively, each operates a portable electronic device 14A, 14B, 14C and 14N, to communicate with a rideshare server system 22 over a communications network 24 to submit an electronic request to travel in one or more vehicles 16 driven by a driver 18 operating a portable electronic device 20. The rideshare server system 22 of FIG. 1 is shown as a client-server architecture wherein a back-office intermediary server 26 communicates with a match engine 28 and a mapping/routing engine 30. The illustrated example portrays a single driver—a private individual—offering transportation for three or more prospective riders in the driver's privately owned coupe-type automobile. However, it is envisioned that the automated ridesharing system 10 include any number of prospective riders seeking a ride from any number of registered drivers operating any logically relevant type of motor vehicle. In this regard, the fleet of available drivers registered with the system 10 may be comprised of private individuals, salaried or contract employees, public transit, private car or taxi service, autonomous vehicles, or any combination thereof.

The communications network 24 of FIG. 1 can be a wired network or a wireless network, or a combination of wired and wireless technology. In at least some aspects, most if not all of the transaction functions performed by the portable electronic devices 14A, 14B, 14C, 14N, 20 can be conducted “wirelessly” over a wireless network, such as a WLAN or cellular data network, to ensure freedom of movement of the riders and drivers. In some implementations, one or more segments of the system 10 can be embodied as web-based components where users or clients use internet-based websites and/or web-based applications to access the transaction features disclosed herein. In various aspects, the portable electronic devices 14A, 14B, 14C, 14N, 20 include a web browser or a dedicated, standalone application software, or a combination of both. A web browser typically allows a user to search for and/or request a web page (e.g., from the rideshare server system 22) with a web page request. A web page, in a non-limiting example, is a data file that includes computer executable or interpretable data, graphics, text, video, and/or sound, that can be executed, displayed, played, processed, streamed, and/or stored, and that can contain links to other web pages. Examples of commercially available web browser software include, but are certainly not limited to, FIREFOX, available from Mozilla Corp., SAFARI available from Apple, Inc., ANDROID BROWSER, available from Google Inc., and INTERNET EXPLORER, available from Microsoft Corp. In one implementation, any disclosed portable electronic device can connect “by wire” to the network 24 via a data cable, which can pertain to a peripheral bus such as a USB or Firewire® (IEEE-1394) connection.

Dedicated application software can be implemented for completing operations by and interactions between the various users (i.e., riders and drivers) and various components of the server system. For instance, the dedicated application software can be in the form of a web-based (e.g., Java) applet that is downloaded to each portable electronic device 14A, 14B, 14C, 14N, 20 and runs in conjunction with a web browser on the device. Optionally, the dedicated application software can be in the form of a standalone software application, which can be implemented in a multi-platform language such as .Net or Java, or in native processor executable code. When executed on a portable electronic device, the dedicated application software may be operable to open a network connection with the rideshare server system 22 over the communications network 24 and, thus, communicates via that connection with the components of the server system 22. In some embodiments, the dedicated application software communicates with a single “host” or “client” server, such as back-office intermediary server 26, which in turn conducts any necessary communications with one or more “third party” servers, such as match engine 28 and a mapping/routing engine 30, to complete a particular transaction. Optionally, the dedicated application software and web browser can be part of a single client-server interface, where the software can be implemented as a “plug-in” to the web browser, for example. As another option, this software application can be embodied as a dedicated mobile software application (more commonly known as a “mobile app” or just “app”) that is downloaded to or otherwise available on the portable electronic device, e.g., as a standard feature with the device's operating system. Other optional variations and known alternatives are considered to be within the scope and spirit of the present disclosure.

In the illustrated system, the network 24 securely communicatively couples each of the portable electronic devices 14A, 14B, 14C, 14N, 20 to one or more servers of the rideshare server system 22. Each server can be implemented on one or more server class computers, which can be subcomponents of a computer hardware server system, with sufficient memory, data storage, and processing power and, in some embodiments, the capabilities to run a server class operating system (e.g., GNU/Linux, SUN Solaris, Microsoft Windows OS, etc.). The servers can each be part of a logical group of one or more servers, such as a server farm or server network. As is typical in large-scale systems, the application software can be implemented in components, with different components running on different server computers, on the same server, or any logical combination thereof. In a non-limiting example, the back-office intermediary server 26 includes a server stack 38 composed of one or more server processors and connected to a main or auxiliary memory 32, which comprises one or more memory devices. The server stack 38 includes any suitable processor(s), such as those made by Intel and AMD. By way of example, the server stack 38 includes a plurality of microprocessors including a master processor, a slave processor, and a secondary or parallel processor. Each memory device may take on the form of any of a variety of memory media, such as CD-ROM, magnetic disk, bubble memory, and semiconductor memory (e.g., various types of RAM or ROM). An external-system interface 34 composed of one or more communication devices facilitates communication and data transfer between the back-office intermediary server 26 and the two offsite engines 28, 30 and a local or remote database 36 composed of one or more data storage modules for storing user-specific data.

In some embodiments, user-input device(s) of the 14A, 14B, 14C, 14N, 20 accept(s) user input(s) and transform the user input(s) to electronic data signals indicative of input or inputs, which can correspond to an enabled feature for such input(s) at a time of activation. The input(s), once transformed into electronic data signals, can be outputted to a central processing unit (CPU) or controller for processing. The electronic data signals can correspond to an electrical current, an electrical voltage, an electrical charge, an optical signal, or a magnetic signal, or any combination thereof.

To enhance security, a transaction with a portable electronic device 14A, 14B, 14C, 14N, 20 can be optionally enabled only by an authentication process in which a primary or secondary source confirms the identity of the user 12A, 12B, 12C, 12N, 18. Upon entry of user identification information, for example, such as a password, PIN number, credit card number, personal information, biometric input, predefined key sequences, etc., the user can be permitted to access a user account. Thus, a transaction can be enabled by, for example, a combination of personal identification input (e.g., mother's maiden name) with a secret PIN number, or a combination of a password and a corresponding PIN number, or a combination of a credit card input with secret PIN number. Other conventional security or authentication features can be utilized to prevent unauthorized access to a user's account, for example, to minimize an impact of any unauthorized access to a user's account, or to prevent unauthorized access to any personal information or funds accessible via a user's account.

Portable electronic device, as used herein, should be given its ordinary and customary meaning accorded by persons of ordinary skill in this art having read and understood this disclosure. For example, a portable electronic device, as used herein, is inclusive of, but not exclusive to, laptop computers, tablet computers, cellular phones and smartphones, personal digital assistants (PDA), e-readers, and the like. In some exemplary applications, the portable electronic devices 14A, 14B, 14C, 14N, 20 illustrated in FIG. 1 are WiFi-enabled and cellular-enabled smartphones, each of which includes various known input devices, e.g., keyboard, buttons, touchscreen, track ball, track pad, microphone, voice and/or gesture recognition software, etc., and output devices, e.g., liquid crystal display (LCD) screen, plasma display screen, light emitting diode (LED) display screen, speaker, audio and/or video output jack, etc. Location and movement of a portable electronic device can be tracked via a location tracking device, which may be resident to or remote from the device. The location/movement can be determined through a satellite-based GPS navigation system. Even without a GPS receiver, a portable electronic device can provide location and movement information through cooperation with a cellular system through trilateration.

With continuing reference to FIG. 1, the multimodal computer-networked ridesharing system 10 is operable for provisioning driver-rider matching as part of an automated ridesharing service. The ridesharing system 10 facilitates, for example, preplanned and/or real-time carpooling in which drivers and riders register with the system and, optionally, go through an approval process prior to participation. As part of the registration process, each driver and each rider may be prompted to enter personal scheduling and preference information; a database of this information is maintained. Drivers create driver trips that may be represented by an origin, a destination, a travel time window, and a maximum detour distance for stops to pick up or drop off prospective riders. Riders similarly create rider trips that may be represented by an origin, a destination, a travel time window, and a maximum detour time for other pick-ups and drop-offs. Riders and/or drivers (collectively referred to herein as “users”) make travel reservations, e.g., through a mobile app on their personal mobile device; reservation data is sent to the back-office database.

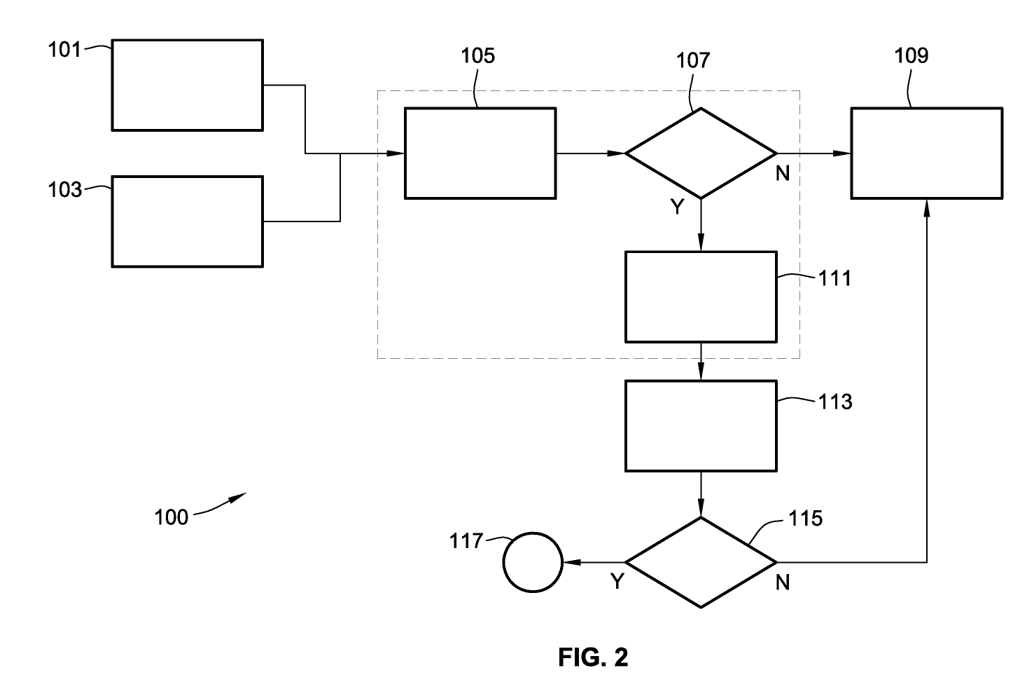

Using this reservation data, as well as user attribute and preference data as inputs, the match engine calls up a matching algorithm, which is described in further detail below with respect to FIG. 2, and generates match groups. Match results may be transmitted electronically back to a user through the mobile app. Rider location can be tracked, for example, through the mobile app on each rider's personal smartphone. Each rider boards the vehicle at or near their preferred origin. When a carpool of matched rider(s) and a driver is in route, a back office intermediary server tracks the location of the vehicle, e.g., either through an on-board transmission device or through the app on the driver's smartphone. Real-time user locations may be shared with all users in the matched group. Riders disembark the vehicle at or near their preferred destination. Riders can be charged a fare using, for example, the distance and/or time between their respective pickup stop and the drop-off stop as a factor, as well as a variable index based on other factors, such as total number of riders, rider-borne delay, driver-borne delay, traffic, etc. Drivers may receive compensation that is proportional to a total fare charged to all of the riders during the trip.

Another optional system feature includes scenarios where users submit ride requests with the ridesharing system 10, e.g., using a mobile app, with all of the users traveling as prospective riders. In such cases, e.g., where an independent driver driving his/her privately owned vehicle is not available or cases where the system 10 restricts or limits registration of independent drivers, the match engine 28 is operable to match prospective riders with an available independent car service, a taxi cab, or an autonomous vehicle, each of which may be designated as an artificial user traveling as an available driver. Current locations of these artificial users may be designated as artificial origins, and an idle artificial user without any current riders on-board may be designated as having a destination of “anywhere” and/or an “infinite” or “open” travel time window. An artificial user that is in route with one or more riders on-board may be designated as having the same destination or destinations as the rider/riders destination(s). Available seating capacity can be updated in real-time, e.g., when riders enter/alight from the vehicle, and an artificial travel time may be constrained by the riders' travel time window(s). A mutual communication device may be installed on each vehicle to transfer vehicle status and match info between the vehicle and the back-office.

During operation of the automated ridesharing system 10, the match engine 28 may require certain inputs and may generate certain outputs. These may include:

Inputs

User Attributes:
Basic: name, age, gender, mailing address
Driving style
User rating
Other individual user information

User Preferences:
Age and/or gender restrictions;
Driver style restrictions for available driver(s);
Minimum rating requirement for matched available drivers (if user is a rider) and/or prospective riders (if user is a driver);
First- and last-mile pick up;
Friend circle preferences and/or black list restrictions;
Other individual user preferences

Travel Request Data:
Travel role: driver, rider, either;
Origin and destination;
Time window: earliest departure and latest arrival times;
Max detour time (and/or distance);
For drivers: seat capacity/max number of available seats (default 1);
For riders: number of people in group (default 1);
For round-trip and multi-trip users: (1) whether okay with only a subset of trips being matched; (2) whether okay to match with different travelers in different trips;
Other individual user travel preferences

Outputs

Matched Users:
Driver and rider(s) in each match group
For a match group with multiple riders: suggested rider pick-up order
Suggested driver departure times
Estimated rider pick-up and drop-off times and locations (default rider preferred pick-up and drop-off locations)

Not-Matched Users:
Users that are not matched
Users that will be stranded

With reference now to the flow chart of FIG. 2, an improved driver-rider matching procedure or method of pairing available drivers with prospective riders associated with a rideshare system, such as automated ridesharing system 10 of FIG. 1, for example, is generally described at 100 in accordance with aspects of the present disclosure. Some or all of the operations illustrated in FIG. 2 and described in further detail below can be representative of an algorithm that corresponds to processor-executable instructions that can be stored, for example, in main or auxiliary memory, and executed, for example, by an ECU, a CPU, a dedicated server component, an on-board or remote control logic circuit, or other device, to perform any or all of the above and/or below described functions associated with the disclosed concepts. It should be recognized that the order of execution of the blocks illustrated in FIG. 2 may be changed, and/or some or all of the blocks shown may be modified, eliminated, combined, or supplemented to include any of the other options and features discussed above and below.

The method 100 begins at block 101 with receiving one or more ride requests from one or more prospective riders soliciting that a ride be coordinated, e.g., by the automated ridesharing system 10. Block 101 may further include determining rider scheduling and preference data for each requesting prospective rider, which may necessitate retrieving the requisite data from a storage module in database 36. Rider scheduling and preference data may be composed of driver related restrictions and travel related requirements dictated by a requesting prospective rider, such as those indicated above in the INPUTS section. For instance, driver related restrictions may include age restrictions, gender restrictions, aggressiveness restrictions, minimum user rating restrictions, blacklisted restrictions, and/or friend circle restrictions. Comparatively, a rider's travel related requirements may include an origin, a destination, a travel time window, a maximum detour time, a number of riders, a number of ride requests, and/or a carpool restriction. For some applications, one or more or all of the foregoing preferences, restrictions and requirements can be provided as part of the initial ride request from the prospective rider.

Block 103 of method 100 includes generating, retrieving or otherwise determining a registry of “existing” drivers associated with the system 10. From this collection of available drivers, the system will determine, at block 105, a set of one or more available drivers that is/are currently or is/are expected to pass within a predetermined proximity of a requesting prospective rider. While it is anticipated that at least one available driver will meet this threshold constraint, it is plausible that no drivers will meet the initial vetting process. In the latter instance, the method 100 may automatically proceed to block 109, which is described below. As an optional or alternative threshold constraint, block 105 may further include receiving, retrieving or otherwise determining a seating capacity sufficient to accommodate the prospective rider's ride request, and contemporaneously determining which of the available drivers do/do not have available seating capacity sufficient for the seating capacity of the ride request. Method 100 will then require eliminating from the set of available drivers any driver with an available seating capacity that is not greater than or equal to the seating capacity needed to accommodate the ride request.

Once the available driver set is established, the method 100 will determine, e.g., at block 105, respective driver scheduling and preference data for each driver in the set. Similar to acquiring each rider's respective scheduling and preference data, determining each driver's respective scheduling and preference data may necessitate retrieving the requisite data from a storage module in database 36. Driver scheduling and preference data may be composed of rider related restrictions and travel related requirements dictated by each of the available drivers in the set, such as those indicated above in the INPUTS section. For instance, rider related restrictions may include age restrictions, gender restrictions, temperament restrictions, blacklisted restrictions, and/or friend circle restrictions. Conversely, a driver's travel related requirements may include an origin, a destination, a travel time window, a maximum detour time, a seating availability, and/or a number of ride offers. For some applications, one or more or all of the foregoing preferences, restrictions and requirements can be provided as part of an initial ride offer from an available driver. To that end, block 103 and/or 105 may also include receiving a ride offer from an available driver who is offering transportation to prospective riders. In this instance, the method 100 will responsively identify a set of prospective riders from which ride requests have been received, and determine respective rider scheduling and preference data for each rider in the set of prospective riders. This information will allow the system 10 to then match an offering driver with one or more prospective riders.

The method 100 of FIG. 2 continues to decision block 107 with determining whether or not the requesting prospective rider matches with any or all of the available drivers in the set created at block 105. For instance, match engine 28 decides whether a prospective rideshare rider can pair or match with an available rideshare driver by “juxtaposing” or otherwise comparing and contrasting each user's travel/schedule requirements (e.g., origin, destination, travel time window, etc.) and personal preferences (e.g., gender, age, match rating, blacklist, friend circle, etc.) to find commonality or lack thereof. If it is determined that the requesting prospective rider does not match with any of the available drivers in the set (Block 107=NO), the method 100 will continue to block 109. At block 109, one or more new determinations are performed to determine whether or not the requesting prospective rider matches with another available driver. Other available drivers may refer to: (1) previously matched drivers that have rejected match suggestions and are looking for new suggestions; or (2) new drivers that submit offers after current matching. In addition, or alternatively, block 109 will comprise saving the ride request for a predetermined finite period of time during which one or more new match determinations are conducted in an attempt to match the rider with a driver. By way of example, the ride request may be kept “active” until a match is found or a predefined expiration time is reached. In practice, some riders may be willing to wait for a few minutes before seeking other modes of transportation, whereas some riders may submit a “carpool” ride request well in advance such that there is ample time to identify one or more potential matches. As such, the system can keep a ride request active in an ongoing attempt to match the rider with drivers who provide a ride offer at a later time or otherwise become available. So expiration time can be defined by the system or by the prospective rider—as a requested cancellation time or a maximum waiting time.

In some instances, a ride request may include a round-trip travel requirement (e.g., a ride to and a ride from work on a particular day) or a multi-trip travel requirement (e.g., rides to and from work for every day in a work week). When determining if a requesting prospective rider matches with one of the available drivers in the set, the system will assess whether or not that available driver can accommodate the round-trip/multi-trip travel requirement. If not, that particular available driver can be removed from the set of available drivers or otherwise designated as a non-match. Conversely, that driver can be downgraded while the system attempts to match the ride-seeking prospective rider with a better suited driver.

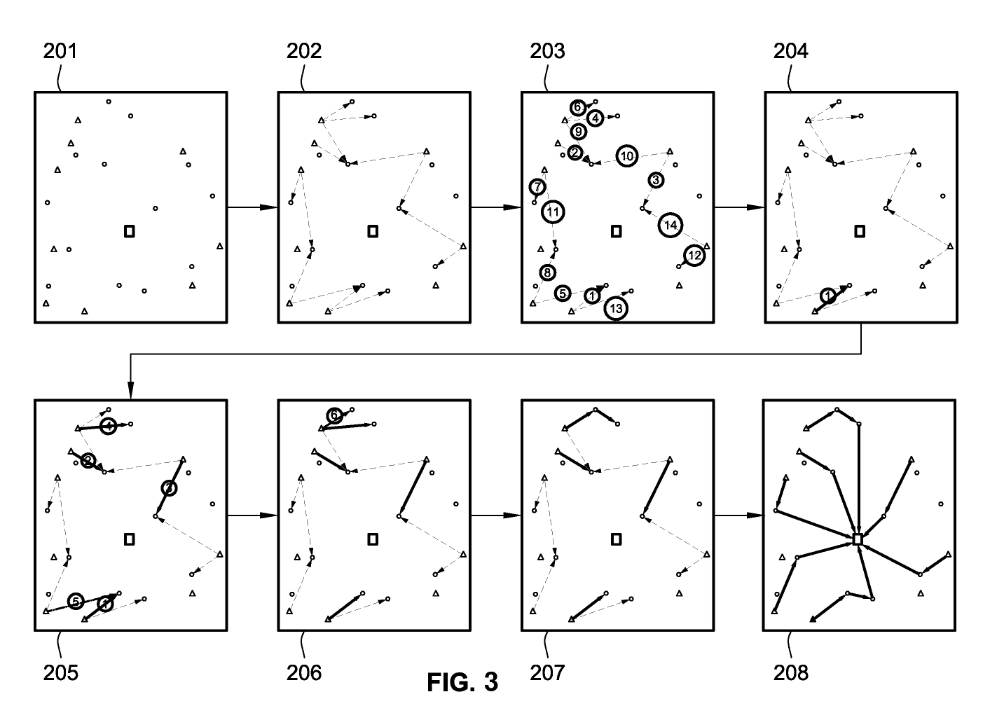

In response to a determination that the requesting prospective rider matches with one or more of the available drivers in the set (Block 107=YES), the method 100 will transmit confirmation of the match to each matched driver at block 113. Thus, if the prospective rider matches with multiple available drivers, block 113 may require transmitting multiple confirmations of the match, which may be in the nature of a text message, an email, a push notification or some other form of electronic notification, and await affirmation from each driver that they are in fact able to transport the prospective rider. Alternatively, the method 100 may sort and prioritize the drivers, e.g., at block 111, based on one or more predefined metrics (e.g., highest match score, shortest detour time, closest in proximity, etc.). In this case, electronic confirmation of the match is only transmitted to a highest prioritized one of the matched drivers or a select subset (e.g., a “top three”) of the matched available drivers; the system then awaits affirmation from these drivers that they are in fact able to transport the prospective rider. As an optional alternative, before moving to Block 113, prioritized drivers can be assigned to riders as final matches at, e.g., after Block 111. Such an “assign” process (see description of FIG. 3) helps to prevent the prospective rider being matched with less prioritized drivers, and could potentially increase the overall matching probability of other riders and drivers.

At block 115, the system determines whether or not they have received a pickup confirmation from any of the matched drivers. If a pickup confirmation has been received, the method 100 will then transmit confirmation of the match to the requesting prospective rider at block 117. If multiple pickup confirmations are received from matched drivers, the system may then transmit confirmation of the match to the requesting prospective rider and the highest prioritized or first-in-time driver at block 117.

Continuing with the above example, a similar procedure can be applied where the automated ridesharing system 10 is attempting to match an offering available driver with one or more prospective rideshare riders. By way of example, and not limitation, after the system has received a ride offer from an available driver, e.g., at block 103, delineated a set of prospective riders seeking rides, e.g., at block 101, and retrieved respective rider scheduling and preference data for each rider in the set e.g., at block 105, the system will then determine, e.g., at block 107, if the offering driver matches with any of the prospective riders in the set. Similar to the matching determination described above, the process of matching offering drivers with ride-seeking prospective riders is based on a comparison between respective rider scheduling and preference data of each rider with the offering driver's scheduling and preference data. Responsive to each determination that a prospective rider in the set matches with the offering available driver, the system, e.g., at block 113, will transmit confirmation of the match to each of the prospective riders and the offering available driver. The method 100 may also sort and prioritize the prospective riders, e.g., at block 111, before transmitting a confirmation of the match to each user.

Disclosed ridesharing systems and methods can help to provide: (1) flexibility—accommodate instances when a driver's or a passenger's schedule changes (unlike conventional carpooling which oftentimes requires all persons in the carpool to commit to a fixed schedule); (2) reliability—accommodates instances when a driver is no longer available to drive on a given day (in contrast to conventional carpooling where persons may become stranded or are left to coordinate another person to drive); (3) coordination and planning—automates the process of coordinating among various potential carpool partners and manage carpool logistics (e.g., meeting places, times, routes, etc.); (4) dependability—minimizes travel delays caused by individual riders (conventionally, if one person in a carpool is late, the entire carpool becomes late).

FIG. 3 presents a series of schematic illustrations—numbered 201-208—portraying a representative “carpool” rideshare environment, wherein an adaptable driver-rider matching algorithm employs filter-sort-assign batch processing operations for matching multiple registered drivers with multiple prospective riders to reach a common destination. In tile 201, there is shown a number of available rideshare drivers, each of which is represented by a triangle, a number of prospective rideshare riders, each of which is represented by a circle, and a workplace, which is represented by the square positioned near the center of the tile. At tile 202, the automated ridesharing system 10 begins Process 1 of finding all feasible one-driver-to-one-rider pairs (each feasible pair is represented by a dashed line). In this example, we use the term “pair” or “pairs” instead of “match” or “matches” because the driver-and-rider(s) assignment is not yet finalized. Next, at tile 203, the system performs Process 2 with sorting pairs using one or more predefined metric, such as those described above (e.g., origin, destination, detour time, etc.). Each circled number in tile 203 represents a possible match based on the aforementioned predefined metric(s), with the lower numbers representative of the “prioritized” pairs.

The filter-sort-assign batch processing operations continue to tile 204 to begin formally matching each rider with an available driver, i.e. finalizing pairs as matches. Tile 204 illustrates Process 3, Case 1, wherein matches are created in sorted order with solid lines representative of a “final match” based on the prioritization of Process 2, whereas dashed lines represent not-yet formally matched pairs. From tile 203, we can see that feasible match (1) is deemed to be the “highest priority” match; as such, in tile 204, this match (1) is shown finalized with a solid line. Continuing to Tile 205, there is shown Process 3, Case 2, where additional matches are created in sorted order, with feasible matches (2), (3) and (4) being finalized, and feasible match (5) being rejected. At tile 206, which is indicative of Process 3, Case 3, additional matches are made in sorted order—in this case, an already matched driver is matched with a second prospective rider, thereby finalizing feasible match (6). This can be seen in tile 207, where the driver from finalized match (4) is rerouted to complete finalized match (6). Tile 208 shows the finalized matches, including multiple matches where a single driver is rerouted to pick up multiple prospective riders.

Different ride share models target different customer needs and provide different user experiences. An “Advance Match” rideshare model, which requires prospective rideshare riders and drivers submit ride request/offers in advance, is a slower, longer process that has a higher probability of matching all users. A call-ahead shuttle bus service can be representative of an Advance Match rideshare model. At the other end of the spectrum is the “Instantaneous Match” rideshare model, which does not require prospective rideshare users submit ride request/offers in advance, such as modern day mobile ridesharing apps typically employed for a single trip (e.g., UBER®, LYFT®, etc.). This model is a much faster process, but has a lower probability of matching all users in high-demand, low-availability scenarios. A third option is the “Dynamic Match” rideshare model, which is a hybrid of the Advance Match model and the Instantaneous Match model. Many of the driver-rider matching algorithms disclosed herein are adaptable to, and thus can be employed for, any of the foregoing rideshare models.

As an example where a disclosed driver-rider matching algorithm is applied in an Advance Match rideshare model, users submit requests well in advance to trip departure, e.g. a few hours to a few days, and the matching process is not initiated until all requests are collected. This Model may be ideal for commuting rideshare users, wherein matching can be done every half-day, day, or longer. In a non-limiting example, the system may require that all PM trip requests be entered into the system by a cut-off time, e.g., 12 pm of the same day. Some systems may require more lead time; in such a case, the system may set a deadline of 5 pm the day before so that AM optimization in the morning can look ahead and generate better match results. Matching is initiated after all user requests are collected. An SMS message and/or an email with hyperlinks are sent to users prompting users to confirm, e.g., by replying “Y”/“N” through SMS or clicking a confirmation link in the email. The system may require that all confirmations be provided between a defined period, e.g., 1-2 pm the day before. Subsequently, optional embodiments may include re-matching trips that are modified or not confirmed. Users with new/modified assignments may be required to submit final confirmation by a defined time, e.g., 3 pm of the same day. Failure to do so may subject the reservation to cancellation. A buffer window can then be added, after which PM commute trips are executed. A similar process can be adapted for AM commute trips.

When sorting feasible pairs in Process 2, as indicated in tile 203 of FIG. 3, in addition or in lieu of considering factors such as cost and time, the system may also need to ensure that a round-trip/multi-trip rider has a match for each segment of his/her submitted request. In at least some embodiments, the priority of each feasible pair may be decided by a user's (e.g., the rider's) assigned role in a previous trip cycle (“look-back”), and/or whether the user has alternative transportation. For example, if a user-rider is picked up for work in the morning, the user-rider should also be dropped off back home in the afternoon; otherwise, that user may be left stranded. For this reason, when matching a round-trip or multi-trip rider in the later segment, the user-rider may need to be given a higher or highest priority. For instance, a user-rider with no alternative transportation and whose previous cycle/segment role is a rider will be assigned with a high priority. The matching algorithm can check the user's previous role to exclude two possibilities: (1) if his/her previous role is a driver, it indicates he/she has a car with him/her; hence, they are likely not subject to being stranded; (2) if he/she was not a user in the previous cycle, it indicates this is the 1st segment of the user's trip; hence, there is no need to assign a high priority at this time as they are less likely to be stranded. For the same reason, when matching a round-trip or multi-trip rider in the first segment, the match process may need to evaluate the probability of successfully finding match driver(s) for the rider in the later segments (“look-forward”). For example, if the chance to find a match driver in at least one of the later segments is low, it is better to reject the rider request in the beginning so that the rider won't get stranded from using the service.

Aspects of this disclosure may be implemented, in some embodiments, through a computer-executable program of instructions, such as program modules, generally referred to as software applications or application programs executed by an on-board vehicle computer. The software may include, in non-limiting examples, routines, programs, objects, components, and data structures that perform particular tasks or implement particular abstract data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, bubble memory, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by remote-processing devices that are linked through a communications network. In a distributed-computing environment, program modules may be located in both local and remote computer-storage media including memory storage devices. Aspects of the present disclosure may therefore, be implemented in connection with various hardware, software or a combination thereof, in a computer system or other processing system.

Any of the methods described herein may include machine readable instructions for execution by: (a) a processor, (b) a controller, and/or (c) any other suitable processing device. Any algorithm, software, or method disclosed herein may be embodied in software stored on a tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well-known manner (e.g., it may be implemented by an application specific integrated circuit (ASIC), a programmable logic device (PLD), a field programmable logic device (FPLD), discrete logic, etc.). Further, although specific algorithms are described with reference to flowcharts depicted herein, persons of ordinary skill in the art will readily appreciate that many other methods of implementing the example machine readable instructions may alternatively be used.

While aspects of the present disclosure have been described in detail with reference to the illustrated embodiments, those skilled in the art will recognize that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined in the appended claims. Moreover, the present concepts expressly include any and all combinations and subcombinations of the preceding elements and features.

What is claimed:

1. A method for matching one or more prospective riders with one or more available drivers associated with an automated ridesharing system, the method comprising:
receiving a ride request from a requesting one of the prospective riders;
determining rider scheduling and preference data for the requesting prospective rider;
determining a set of the one or more available drivers currently or prospectively within a predetermined proximity of the requesting prospective rider, if any;
determining respective driver scheduling and preference data for each of the available drivers in the set;
determining if the requesting prospective rider matches with any of the available drivers in the set based on the rider scheduling and preference data and the driver scheduling and preference data; and
responsive to a determination that the requesting prospective rider matches with one of the available drivers in the set, transmitting confirmation of the match to the requesting prospective rider and the matched available driver.

2. The method of claim 1, further comprising:
receiving a ride offer from an offering one of the available drivers;
determining a set of the prospective riders from which ride requests have been received; and
determining respective rider scheduling and preference data for each of the requesting prospective riders in the set of prospective riders.

3. The method of claim 2, further comprising:
determining if the offering available driver matches with any of the prospective riders in the set based on the respective rider scheduling and preference data of each rider in the set and the driver scheduling and preference data of the offering available driver; and
responsive to each determination that a prospective rider in the set matches with the offering available driver, transmitting confirmation of the match to each of the prospective riders and the offering available driver.

4. The method of claim 1, further comprising:
determining a seating capacity sufficient to accommodate the ride request from the requesting prospective rider;
determining which drivers in the set of available drivers do not have an available seating capacity greater than or equal to the sufficient seating capacity for the ride request; and
eliminating from the set of available drivers any drivers with an available seating capacity that is not greater than or equal to the sufficient seating capacity for the ride request.

5. The method of claim 1, further comprising, responsive to a determination that the requesting prospective rider does not match with any of the available drivers in the set, performing one or more new determinations of whether or not the requesting prospective rider matches with any of the available drivers.

6. The method of claim 1, further comprising, responsive to a determination that the requesting prospective rider does not match with any of the available drivers in the set, saving the ride request for a predetermined period of time.

7. The method of claim 1, further comprising, responsive to a determination that the requesting prospective rider matches with multiple ones of the available drivers in the set, transmitting a confirmation of the match to the requesting prospective rider and a highest prioritized one of the matched available drivers.

8. The method of claim 1, further comprising, responsive to a determination that the requesting prospective rider matches with multiple ones of the available drivers in the set:
transmitting confirmations of the match to each one of the matched available drivers;
receiving a pickup confirmation from a matched available driver; and
responsive to receiving the pickup confirmation, transmitting confirmation of the match to the requesting prospective rider.

9. The method of claim 1, wherein the ride request includes a round-trip travel requirement, and wherein the determining if the requesting prospective rider matches with any of the available drivers in the set includes determining if each of the available drivers in the set can accommodate the round-trip travel requirement.

10. The method of claim 1, wherein the rider scheduling and preference data includes driver related restrictions and travel related requirements provided by the requesting prospective rider.

11. The method of claim 10, wherein the driver related restrictions include age restrictions, gender restrictions, aggressiveness restrictions, minimum user rating restrictions, blacklisted restrictions, or friend circle restrictions, or any combination thereof, and wherein the travel related requirements include an origin, a destination, a travel time window, a maximum detour time, a number of riders, a number of ride requests, or a carpool restriction, or any combination thereof.

12. The method of claim 1, wherein the driver scheduling and preference data includes rider related restrictions and travel related requirements provided by each of the available drivers in the set.

13. The method of claim 12, wherein the rider related restrictions include age restrictions, gender restrictions, temperament restrictions, blacklisted restrictions, or friend circle restrictions, or any combination thereof, and wherein the travel related requirements include an origin, a destination, a travel time window, a maximum detour time, a seating availability, or a number of ride offers, or any combination thereof.

14. An automated ridesharing system comprising:
one or more server processors communicatively connected to one or more data storage modules;
one or more communication devices communicatively connecting at least one of the one or more server processors with a match engine or a map/routing engine, or both, via a distributed computer network; and
one or more memory devices communicatively connected to at least one of the one or more server processors, at least one of the one or more memory devices storing processor-executable instructions, the processor-executable instructions including:
process a ride request received from a personal computing device of a requesting one of a plurality of prospective riders;
retrieve, from at least one of the one or more data storage modules, rider scheduling and preference data for the requesting prospective rider;
create, from a registry of drivers associated with the automated ridesharing system, a set of one or more available drivers currently or prospectively within a predetermined proximity of the requesting prospective rider, if any;
retrieve, from at least one of the one or more data storage modules, respective driver scheduling and preference data for each available driver in the set;
compare the rider scheduling and preference data with each of the driver scheduling and preference data to determine if the requesting prospective rider matches with any of the available drivers in the set; and
responsive to a determination that the requesting prospective rider matches with one of the available drivers in the set, transmit confirmation of the match to the requesting prospective rider and the matched available driver.

15. The automated ridesharing system of claim 14, wherein the processor-executable instructions further comprise:
process a ride offer from a personal computing device of an offering one of the available drivers;
create, from a registry of riders associated with the automated ridesharing system, a set of prospective riders from which ride requests have been received; and
retrieve, from at least one of the one or more data storage modules, respective rider scheduling and preference data for each of the requesting prospective riders in the set of prospective riders.

16. The automated ridesharing system of claim 15, wherein the processor-executable instructions further comprise:
compare the driver scheduling and preference data of the offering available driver with the respective rider scheduling and preference data of each rider in the set to determine if the offering available driver matches with any of the prospective riders in the set; and
responsive to each determination that a prospective rider in the set matches with the offering available driver, transmit confirmation of the match to the each of the prospective riders and the offering available driver.

17. The automated ridesharing system of claim 14, wherein the processor-executable instructions further comprise:
determine a seating capacity sufficient to accommodate the ride request received from the requesting prospective rider;
determine which drivers in the set of available drivers do not have an available seating capacity greater than or equal to the sufficient seating capacity for the ride request; and
eliminate from the set of available drivers any drivers with an available seating capacity that is not greater than or equal to the sufficient seating capacity for the ride request.

18. The automated ridesharing system of claim 14, wherein the processor-executable instructions further comprise, responsive to a determination that the requesting prospective rider does not match with any of the available drivers in the set, perform a new determination of whether or not the requesting prospective rider matches with any of the available drivers.

19. The automated ridesharing system of claim 14, wherein the processor-executable instructions further comprise, responsive to a determination that the requesting prospective rider does not match with any of the available drivers in the set, save the ride request for a predetermined period of time.

20. The automated ridesharing system of claim 14, wherein the processor-executable instructions further comprise, responsive to a determination that the requesting prospective rider matches with multiple ones of the available drivers in the set:
transmit confirmations of the match to each one of the matched available drivers;
receive a first-in-time pickup confirmation from a matched available driver; and
responsive to receiving the first-in-time pickup confirmation, transmit confirmation of the match to the requesting prospective rider.
